(19) United States
(12) Patent Application Publication
(10) Pub. No.: US 2021/0199129 A1
(43) Pub. Date: Jul. 1, 2021

(54) Tightly Assembled Ceiling Fan

(71) Applicant: Fujian Huada Electric Co., Ltd, Fujian (CN)

(72) Inventor: Nai Hua Xiao, Fujian (CN)

(21) Appl. No.: 16/728,023

(22) Filed: Dec. 27, 2019

(51) Int. Cl. F04D 29/64; F16M 13/02

(52) U.S. Cl. CPC F04D 29/646; F16M 13/027

(57) ABSTRACT

A tightly assembled ceiling fan comprises a hanging structure, a fan body and several fan leaves. The hanging structure is locked to a firmed portion at height place. The fan body is disposed at a lower place of the hanging structure. A top surface of the fan body is opened with a circular recess cavity and contains and is locked with a circularly assembling ring. A periphery of the assembling ring is outwardly extended with several assembling plates at uniformly divided positions. The assembling plate is correspondingly disposed with an upper pressing plate. An internal end portion of the upper pressing plate descends to form an assembling end plate. The assembling end plate is locked to the assembling ring and the top portion of the fan body. An internal space of the fan leaf is formed with a set of positioning rods, and left and right sides have an erect bone, respectively. An internal end head of a fan leaf is correspondingly inserted toward an assembling plate and the upper pressing plate so that the assembling plate enters a space encircled by the positioning rod and two erect bones. At the same time, the upper pressing plate is pasted to an external wall of the top surface of the fan leaf to achieve lock and connection.

### BACKGROUND OF THE INVENTION

### Field of the Invention

The present invention relates to a tightly assembled ceiling fan, and more particularly to a tightly assembled ceiling fan capable of enhancing tightness of assembling fan leaves to prevent fan leaves from suddenly falling to harm people and damage assets.

### Description of the Related Art

In general, a ceiling fan is installed to a high position of a building such as an indoor ceiling or a factory roof, and the ceiling fan is usually rotated clockwise or counterclockwise (viewing from below). For the ceiling fan that adopts the clockwise rotation, the airflow produced by the rotation of the ceiling fan blows (or pushes) air downward to produce wind below. If such ceiling fan is operated together with an air-conditioner, the indoor temperature can be reduced quickly and effectively. For the ceiling fan that adopts the counterclockwise rotation, the airflow produced by the rotation of the ceiling fan blows (pushes) air upward for the following two effects. If the internal environment of the building is in a high temperature (in a hot area), the counterclockwise rotation of the ceiling fan pushes the airflow upward to draw the hot air below to the upper part, and then send the hot air to the outside through a pipe channel (such as an exhaust fan) installed at an upper sidewall, so that the environment below can be cooled quickly. If the internal environment of the building is in a low temperature (in a cold area), the counterclockwise rotation of the ceiling fan will blow and sends the cold airflow upward to draw the cold air below to an upper place due to the principle of thermal rise and cold drop, and the indoor hot air will be trapped at the high place. Therefore, the counterclockwise rotation blows and draws the cold air below to the upper place, and the hot air above will be squeezed and pushed along the sidewall downward to the ground, so that the environment below will be distributed with hot air quickly to increase the temperature, which is conducive to the uniform indoor heat distribution in winter.

A conventional ceiling fan is composed of assembling a hanging mechanism, a fan body and several fan leaves. The hanging mechanism is provided for being hanged at a building height place. The fan body is assembled below the hanging structure and mainly has a driving structure inside therein for driving the fan body to rotate. The several fan leaves are uniformly divided and assembled at a periphery of the fan body. The driving structure normally utilizes a motor driven by electric power, and the motor added with an electrical control mechanism (motor electrical components capable of controlling switches and rotational speed) becomes the driving structure. While in assembling, the driving structure is contained in a housing to position so as to compose the fan body. Therefore, while hanging the hanging mechanism at the building height place, the fan body comprising the driving structure is suspended below the hanging mechanism. At the same time, the several fan leaves are uniformly scattered to the periphery of the fan body. The several fan leaves are pushed to rotate by actuating the driving structure.

In the conventional ceiling fan, the assembling between the several fan leaves and the fan body is normally to dispose plural joining pieces uniformly distributed. Afterward the several fan leaves are correspondingly arranged to join the plurality of joining pieces one to one, and the fan leaf and the; joining piece are passed by screw bolts to achieve locking. Since the ceiling fan is at dynamic state during usage, and the fan leaf is continuously affected by rotational centrifugal force, and screw bolt forwardly screws along taper screw threads to lock and fasten, it is ejected to form looseness posture along the taper screw threads during vibration. Upon influence of foregoing factors, at rotation state, one of fan leaves of the ceiling fan suddenly comes off and obliquely throws to harm people and damage assets. The reason of previous accident is that the assembling between the several fan leaves and the fan body in the conventional ceiling fan is too simple and crude.

### SUMMARY OF THE INVENTION

Since the assembling between fan leaves and the fan body of a conventional fan is too primitive, the fan leaves may have potential danger of easily and suddenly coming off and falling. The inventor(s) thinks the problem needs to be improved and deeply researches to finally create the innovate fan upon long term effort.

Therefore, it is a primary objective of the present invention to provide a tightly assembled fan capable of enhancing tightness of assembling fan leaves to prevent fan leaves from suddenly coming off and falling to harm people and damage assets.

To achieve the above-mentioned objective, a tightly assembled ceiling fan is provided through research and development, comprising a hanging structure composed of at least a fastening rack and two support plates, the fastening rack locked with a firm portion at height place, the two support plates symmetrically disposed and locked at two outsides of the fastening rack, a lower section of the two support plates inwardly bending and then descending after passing through a bottom end of the fastening rack; a fan body disposed at a lower place of the hanging structure, an inside of the fan body having a driving structure for driving the fan body rotate, the fan body upwardly protruded with a fastening shaft from a center of the driving structure, the fastening shaft locked to the two support plates after upwardly stretching into the lower section of the two support plates, a central upper place of the driving structure protruded with a bearing portion while an inner bottom center of the driving structure is disposed with a bearing portion, the two bearing portions being between the fastening shaft and the driving structure; a top surface of the fan body opened with a circular recess cavity and containing a circular assembling ring, the assembling ring locked to the top surface of the fan body, a periphery of the assembling ring outwardly extended with several assembling plates at uniformly divided positions, the assembling plate correspondingly disposed with an upper pressing plate, an inner end portion of the upper pressing plate descending to form an assembling end plate, the assembling end plate locked to the assembling ring and the top portion of the fan body; and several fan leaves, the fan leaf being a long strip skeleton that is outwardly extended, an internal space of the fan leaf formed with a set of positioning rods, the positioning rod connected to the top surface and having a spacing between the top surface and the bottom surface, left and right sides of the fan leaf having an erect bone, respectively, an internal side surface of the erect bone close to a bottom portion recessed with a symmetrically positioning notch, respectively, the spacing corresponding to a height of an assembling plate, a distance between the two positioning notches at left and right sides corresponding to a width of an assembling plate; an internal end head of a fan leaf correspondingly inserted toward an assembling plate and the upper pressing plate so that the assembling plate is inserted into a space encircled by the spacing and the two positioning notches, the upper pressing plate pasted to an external wall of the top surface of the fan leaf to achieve lock connection.

According to the above-mentioned tightly assembled ceiling fan, a horizontal cross-section of the upper pressing plate is concave arc shape that is downwardly bent toward two sides.

Accordingly to the above-mentioned tightly assembled ceiling fan, a quantity of the fan leaf is equivalent to numbers of the assembling plate and the upper pressing plate.

### BRIEF DESCRIPTION OF THE DRAWINGS

FIG. 1 is a three-dimensional drawing according to an embodiment of the present invention;

FIG. 2 is an assembled cross-sectional drawing according to the embodiment of the invention;

FIG. 3 is a partial decomposed three-dimensional drawing I according to the embodiment of the invention;

FIG. 4 is a partial decomposed three-dimensional drawing II according to the embodiment of the invention;

FIG. 5 is a three-dimensional drawing of a fan leaf according to the embodiment of the invention;

FIG. 6 is a horizontal cross-sectional drawing of tightly assembling the fan leaf according to the embodiment of the invention; and

FIG. 7 is a vertical cross-sectional drawing of tightly assembling the fan leaf according to the embodiment of the invention.

### DETAILED DESCRIPTION OF THE PREFERRED EMBODIMENTS

The technical characteristics, contents, advantages and effects of the present invention will be apparent with the detailed description accompanied with related drawings of two preferred embodiments as follows.

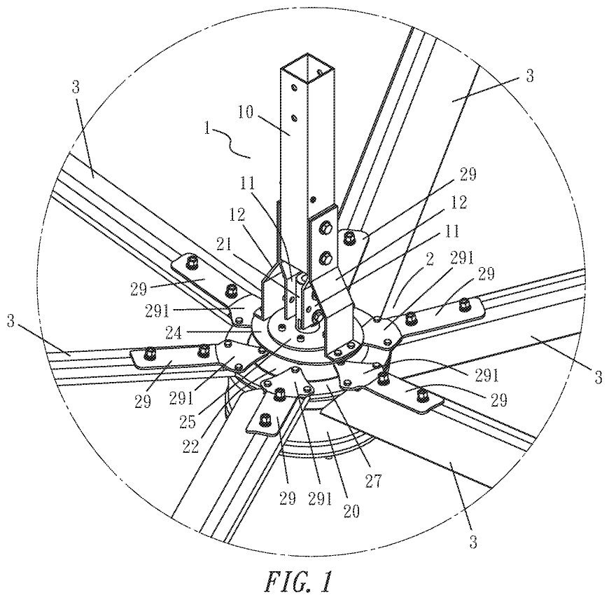

With reference to FIGS. 1-3, the ceiling fan according to the invention is formed by assembling a hanging structure 1, a fan body 2 and several leaves 3, wherein the hanging structure 1 is composed of a fastening rack 10 and two support plates 11. The fastening rack 10 is locked to a firmed portion at a building height. The support plates 11 are symmetrically disposed and pierced by screw bolts to locked two external sides of the fastening rack 10. A lower section of the two support plates 11 is inwardly bent and then descends after passing through a bottom end of the fastening rack 10, and the two plates 11 and the a fastening shaft 21 of the fan body 2 that is upwardly protruded are passed and locked by screw bolts. For more safety, external sides of the two support plates 11 can be further pasted to a connection plate 12, respectively. Moreover, the connection plates 12 and the two support plates 11 are also passed by screw bolts to lock at an external side of the fastening rack 10. Lower sections of the two connection plates 12 are outwardly bent and then descend, and its tail ends and a baffle 24 circularly disposed at a periphery of the fan body 2 are passed and locked by screw bolts. The fastening shaft 21 and the baffle 24 are further described.

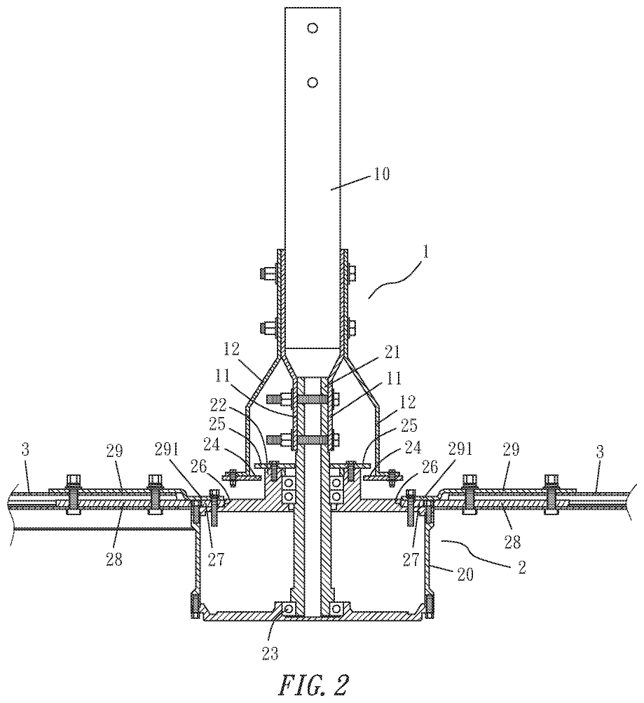

The fan body 2 is assembled to a lower place of the hanging structure 1. An inside of the fan body 2 is a rotor (not shown in the figure). The driving structure 20 is used to drive the fan body 2 to rotate. The fastening shaft 21 is upwardly protruded from a center of the driving structure 20 and achieves stable locking together with the two support plates 11 and the two connection plates 12 through screw bolts. A bearing portion 22 is protruded from a central upper plate of the driving structure 20. An internal bottom center of the driving structure 20 is also disposed with a bearing portion 23 (as shown in FIG. 2). Two bearing portions 22, 23 are between the fastening shaft 21 and the driving structure 20 so that when the driving structure 20 drives the fan body 2 to rotate, the fastening shaft 21 does not rotate. A top surface of the bearing shaft 22 is locked to a pallet 25 through passing of screw bolts. The baffle 24 is circularly disposed at a periphery of the bearing portion 22. A spacing is among the baffle 24, the bearing portion 22 and the pallet 25. A periphery portion of the pallet 25 located above the baffle 24 (as shown in FIG. 2), and its effect is that if the fastening shaft 21 is broken, the pallet 25 is held by the baffle 24 as long as the fan body 2 downwardly deflects. Suddenly, the fan body 2 and several fan leaves 3 are blocked to prevent from dropping so that it can avoid smashing personals and damaging assets. However, effect of the baffle 24 holding the pallet 25 is not a point of the invention, and herein is no more detail describe.

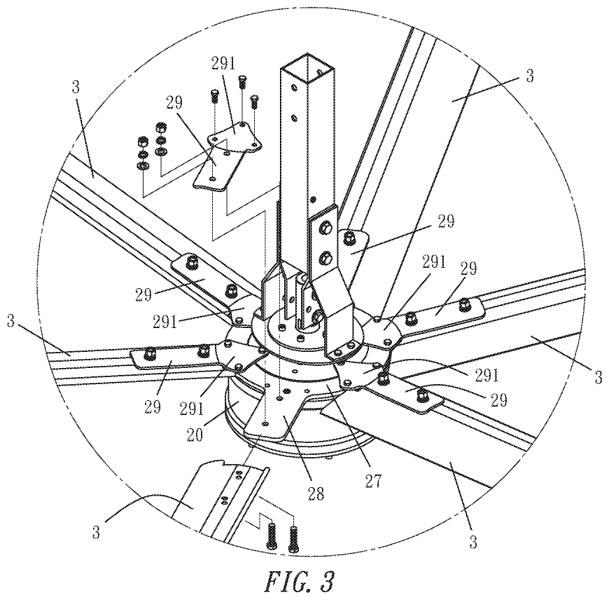

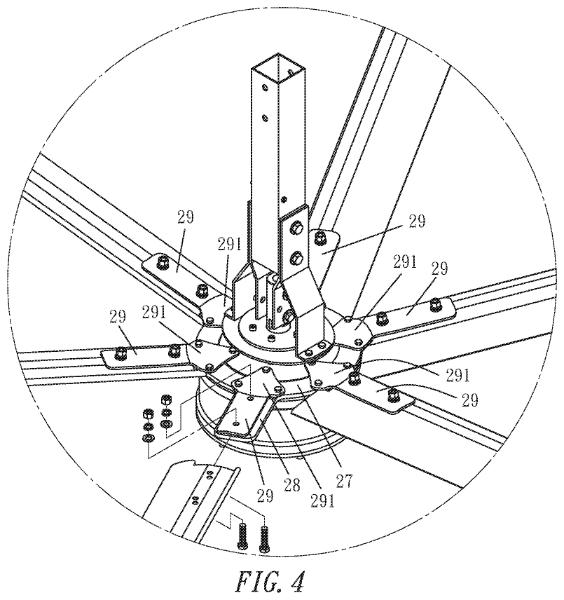

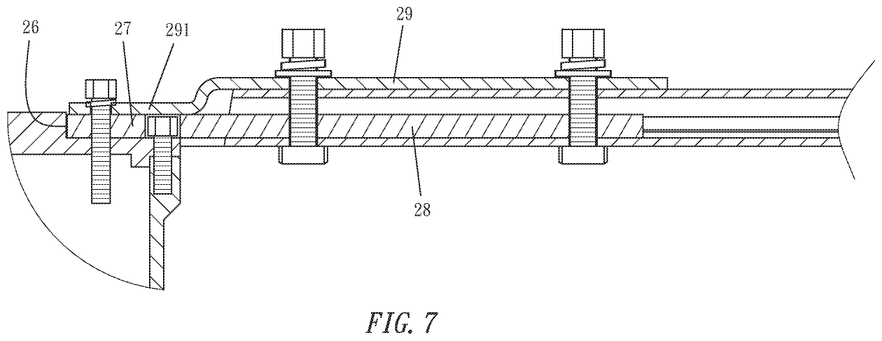

With reference to FIGS. 2, 3, a periphery of a top surface of the fan body 2 is opened with a circular recess cavity 26 (as shown in FIGS. 2, 7) and contains a circular assembling ring 27. The assembling ring 27 completely fills a space of the recess cavity 26, and the assembling ring 27 and the top surface of the fan body 2 are passed by screw bolts to achieve stable locking. A periphery of the assembling ring 27 is outwardly extended with several assembling plates 28 at uniformly divided positions (as shown in FIGS. 2, 3, 4, 6, 7). A quantity of the assembling plate 28 takes 6 pieces as normal condition and does not limited. The assembling plate 28 is correspondingly connected to an upper pressing plate 29. Its horizontal cross-section is concave arc shape that is downwardly bent toward two sides. An internal end portion of the upper pressing plate 29 descends to form an assembling end plate 291. The assembling end plate 291 is pasted to the assembling ring 27 and the top portion of the fan body 2 and is passed by screw bolts to achieve stable locking so that each assembling plate 29 corresponds to an upper pressing plate 29, and a quantity of the upper pressing plate 29 is equivalent to a quantity of the assembling plate 28.

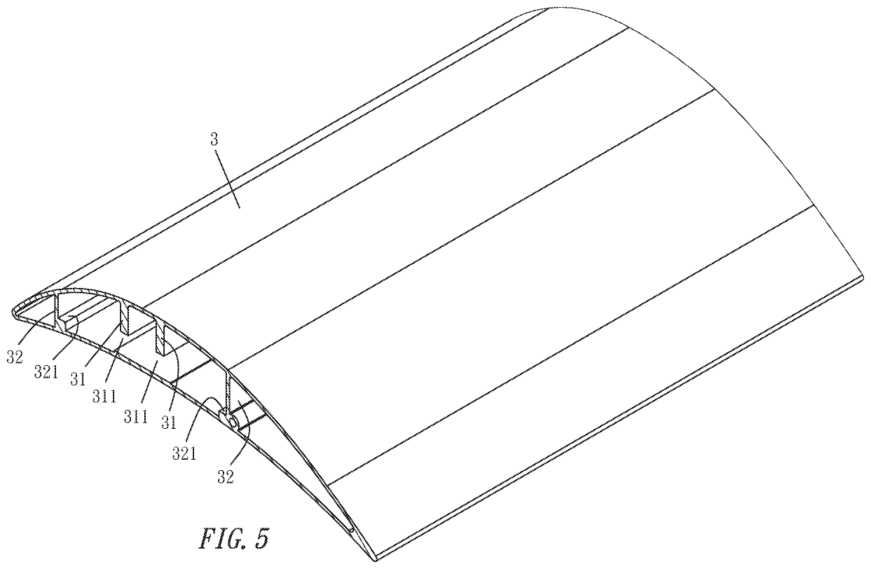

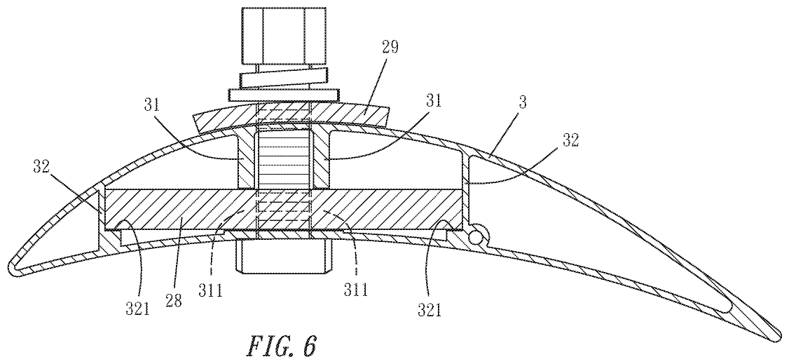

With reference to FIGS. 5, 6, a quantity of several fan leaves 3 is equivalent to a quantity of the upper pressing plate 29. The fan leaf 3 is a long strip a skeleton that is outwardly extended. A set of positioning rods 31 is formed in an internal space of an internal end head structure of the fan leaf 3. The positioning rod 31 is connected to a top surface, and a spacing 311 is between the top surface and the bottom surface. A left and right sides have an erect bone 32, respectively. An internal side of the erect bone 32 close to a bottom place is recessed with a symmetrically positioning notch 321, respectively. The spacing 311 corresponds to a height of an assembling plate 28. The distance between the two positioning notches 321 at the left and right sides corresponds to a width of an assembling plate 28.

According to the foregoing structures, while in assembling, the assembling ring 27 is correspondingly assembled to the recess cavity of the top surface of the fan body 2. Since the assembling ring 27 and the recess cavity 26 are opened with correspondingly screwing holes in advance, screw bolts pass through the screwing holes of the assembling ring 27 to achieve stable screwing together with the screwing holes on the recess cavity 26. After completing the assembling between the assembling ring 27 and the recess cavity 26, the assembling plate 28 at the periphery of the assembling ring 27 is at outwardly extended state from uniformly divided position. Next, the upper pressing plate 29 is pasted to the assembling ring 27 and the top portion of the fan body 2 from its assembling end plate 291. Since the assembling end plate 291, the assembling ring 27, the top portion of the fan body 2 are passed with correspondingly screwing holes in advance, the screwing holes of the assembling end plate 291 are passed by screw bolts to achieve stable screwing together with screwing holes on the top portion of the fan body 2 and the assembling ring 27. After completing the assembling among the assembling end plate 291, the assembling ring 27, and the top portion of the fan body 2, each assembling plate 28 corresponds to one upper pressing plate 29, and a distance exists between the assembling plate 28 and the upper pressing plate 29.

Finally, several fan leaves 3 are assembled to each assembling plate 28 and the upper pressing plate 29 one to one as shown in FIGS. 6, 7, the internal end head of a fan leaf 3 is correspondingly inserted toward a direction of an assembling plate 27 and the upper pressing plate 29. In the process, the assembling plate 28 would be inserted into a space encircled by the spacing 311 and two positioning notches 321 at left and right sides. At the same time, the upper pressing plate 29 is pasted to a top surface external wall of the fan leaf 3. Since screwing holes are disposed to the upper pressing plate 29, the top wall of the fan leaf 3, the assembling plate 28 and the bottom wall of fan leaf 3 in advance, the upper pressing plate 29, the top wall of the fan leaf 3, the assembling plate 28, and the bottom wall of the fan leaf 3 are passed by the screw bolt to achieve stable screwing.

After completing the assembling among the fan leaf 3, the assembling plate 28 and the upper pressing plate 29, with refer to FIG. 6, the screw bolt exactly passes through the space between the two positioning rods 31 after the screw bolt passes through the upper pressing plate 29 and the top wall of the fan leaf 3. It can also be seen that the assembling plate 28 is exactly snapped and positioned by the spacing 311 and the two positioning notches 321 at right and left sides. Therefore, as long as the assembling plate 28 is at immobile state, the fan leaf 3 is not moved neither. At the same time, the fan leaf 3 is commonly pressed and positioned by the assembling plate 28 and the upper pressing plate 29 so that an effect of firmed assembling between the fan leaf 3 and the fan body 2 can be achieved. Accordingly, the fan leaves 3 may not loose and come off even if it is used for long term.

While the present invention has been described by means of specific embodiments, numerous modifications and variations could be made thereto by those skilled in the art without departing from the scope and spirit of the invention set forth in the claims.

What is claimed is:

1. A tightly assembled ceiling fan comprising:
a hanging structure composed of at least a fastening rack and two support plates, the fastening rack locked with a firm portion at height place, the two support plates symmetrically disposed and locked at two outsides of the fastening rack, a lower section of the two support plates inwardly bending and then descending after passing through a bottom end of the fastening rack;
a fan body disposed at a lower place of the hanging structure, an inside of the fan body having a driving structure for driving the fan body rotate, the fan body upwardly protruded with a fastening shaft from a center of the driving structure, the fastening shaft locked to the two support plates after upwardly stretching into the lower section of the two support plates, a central upper place of the driving structure protruded with a bearing portion while an inner bottom center of the driving structure is disposed with a bearing portion, the two bearing portions being between the fastening shaft and the driving structure; a top surface of the fan body opened with a circular recess cavity and containing a circular assembling ring, the assembling ring locked to the top surface of the fan body, a periphery of the assembling ring outwardly extended with several assembling plates at uniformly divided positions, the assembling plate correspondingly disposed with an upper pressing plate, an inner end portion of the upper pressing plate descending to form an assembling end plate, the assembling end plate locked to the assembling ring and the top portion of the fan body; and
several fan leaves, the fan leaf being a long strip skeleton that is outwardly extended, an internal space of the fan leaf formed with a set of positioning rods, the positioning rod connected to the top surface and having a spacing between the top surface and the bottom surface, left and right sides of the fan leaf having an erect bone, respectively, an internal side surface of the erect bone close to a bottom portion recessed with a symmetrically positioning notch, respectively, the spacing corresponding to a height of an assembling plate, a distance between the two positioning notches at left and right sides corresponding to a width of an assembling plate; an internal end head of a fan leaf correspondingly inserted toward an assembling plate and the upper pressing plate so that the assembling plate is inserted into a space encircled by the spacing and the two positioning notches, the upper pressing plate pasted to an external wall of the top surface of the fan leaf to achieve lock connection.

2. The tightly assembled ceiling fan of claim 1, wherein a horizontal cross-section of the upper pressing plate is concave arc shape that is downwardly bent toward two sides.

3. The tightly assembled ceiling fan of claim 1, wherein a quantity of the fan leaf is equivalent to numbers of the assembling plate and the upper pressing plate.
